(19) United States
(12) Patent Application Publication
(10) Pub. No.: US 2016/0306880 A1
(43) Pub. Date: Oct. 20, 2016

(54) METHOD AND APPARATUS FOR IDENTIFYING AUDIO INFORMATION

(71) Applicant: Xiaomi Inc., Beijing (CN)

(72) Inventors: Lu LV, Beijing (CN); Shen LI, Beijing (CN); Tao GUO, Beijing (CN)

(73) Assignee: Xiaomi Inc., Beijing (CN)

(21) Appl. No.: 15/080,329

(22) Filed: Mar. 24, 2016

(30) Foreign Application Priority Data
Apr. 15, 2015 (CN) 201510178987.0

(51) Int. Cl. G06F 17/30; H04L 29/06; G06F 3/16; G06F 17/22

(52) U.S. Cl. CPC G06F 17/30743; G06F 17/2235; H04L 65/4023; G06F 3/165

(57) ABSTRACT

A method and apparatus for identifying audio information, which fall within the technical field of audio identification, are provided. The method for identifying audio information includes obtaining audio that is being played, extracting audio features from the audio, transmitting the audio features to a server, the audio features being matched with audio information stored in the server, receiving the audio information from the server, displaying a hyperlink including a keyword in the audio information on a screen of a device, and displaying prestored information corresponding to the keyword. The audio information of the audio that is being played is obtained by identifying the audio, the hyperlinks that are configured for the keywords in the audio information are displayed, and the prestored information corresponding to the keywords is displayed when the jump link is triggered.

The application is based upon and claims priority to Chinese Patent Application No. 201510178987.0 filed on Apr. 15, 2015, the entire contents of all of which are incorporated herein by reference.

### FIELD OF THE INVENTION

The disclosure relates to a technical field of audio identification, and in particular to a method and apparatus for identifying audio information.

### BACKGROUND

When listening to radio broadcast, a user often cannot obtain relevant information on audio that he is listening to.

### SUMMARY OF THE INVENTION

A method and apparatus for identifying audio information are provided.

In a first aspect of an embodiment of the disclosure, a method for identifying audio information is provided. The method includes obtaining audio that is being played, extracting audio features from the audio, transmitting the audio features to a server, receiving the audio information from the server, displaying a hyperlink including a keyword in the audio information on a screen of the device, and displaying prestored information related to the keywords when the hyperlink is triggered.

In a second aspect of the embodiment of the disclosure, an apparatus for identifying audio information is provided. The apparatus includes an identifying module configured to identify audio that is being played to obtain audio information of the audio, a first displaying module configured to display jump links that are configured for keywords in the audio information, which is obtained by the identifying module, on an information presentation interface, and a second displaying module configured to display prestored information corresponding to the keywords when the jump links displayed by the first displaying module are triggered.

In a third aspect of the embodiment of the disclosure, an apparatus for identifying audio information is provided. The apparatus includes a processor, and a memory for storing instructions executable by the processor. The processor is configured to obtain audio that is being played, extract audio features from the audio, transmit the audio features to a server, receive the audio information from the server, display a hyperlink including a keyword in the audio information on a screen of the device, and display prestored information related to the keyword when the hyperlink is triggered.

Technical solutions provided by the embodiment of the disclosure can achieve the following technical effects.

The audio information of the audio that is being played is obtained by identifying the audio, the hyperlinks that are configured for the keywords in the audio information are displayed, and the prestored information corresponding to the keywords is displayed when the hyperlinks are triggered. As more information corresponding to the audio can be displayed by providing the hyperlinks, the problem that information to be displayed is relatively less due to displaying the audio information merely within a single interface is solved, and the effect of improving diversity of the audio information is achieved.

It should be appreciated that the above general descriptions and the following detailed descriptions are merely illustrative, and are not intended to limit the disclosure.

### DESCRIPTION OF THE DRAWINGS

The accompany drawings that are incorporated into the specification and constitute parts of the specification illustrate embodiments of the disclosure, and are used to explain the principle of the disclosure in combination with the specification.

FIG. 1 is a flow chart illustrating a method for identifying audio information in accordance with an exemplary embodiment;

FIG. 2A is a flow chart illustrating a method for identifying audio information in accordance with another exemplary embodiment;

FIG. 2B is a flow chart illustrating a method for obtaining audio information in accordance with an exemplary embodiment;

FIG. 2C is a diagram illustrating the displaying of audio information and jump links in accordance with an exemplary embodiment;

FIG. 2D is a diagram illustrating the displaying of jump pages in accordance with an exemplary embodiment;

FIG. 3A is a flow chart illustrating a method for playing or downloading audio that is being listened to in accordance with an exemplary embodiment;

FIG. 3B is diagram illustrating the displaying of a play link and a download link for audio in accordance with an exemplary embodiment;

FIG. 4A is a flow chart illustrating a method for searching for a keyword in audio information in accordance with an exemplary embodiment;

FIG. 4B is a diagram illustrating the displaying of search results corresponding to a keyword in accordance with an exemplary embodiment;

FIG. 5 is a block diagram illustrating an apparatus for identifying audio information in accordance with an exemplary embodiment;

FIG. 6 is a block diagram illustrating an apparatus for identifying audio information in accordance with another exemplary embodiment;

FIG. 7 is a block diagram illustrating an apparatus for identifying audio information in accordance with an exemplary embodiment.

### DETAILED DESCRIPTION

Exemplary embodiments will be described in detail herein, wherein examples of the embodiments are shown in the accompany drawings. In the drawings, like reference numbers denote similar or same elements throughout different views, unless otherwise stated. The implementations described in the following exemplary embodiments do not represent all implementations in accordance with the disclosure. In contrary, the implementations are merely examples of the apparatuses and methods that are recited in the claims in accordance with some aspects of the disclosure.

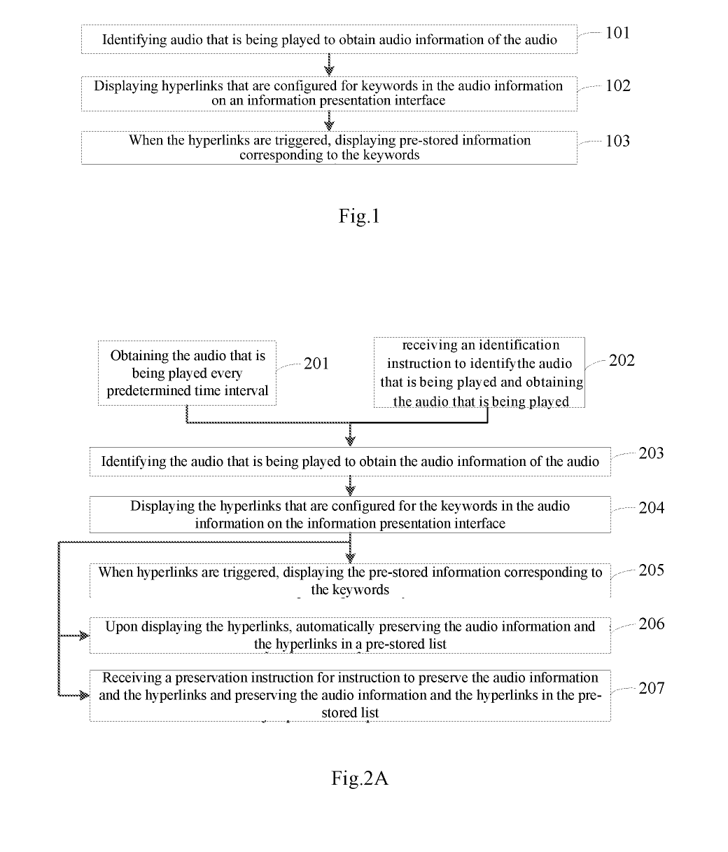

FIG. 1 is a flow chart illustrating a method for identifying audio information in accordance with an exemplary embodiment. The method for identifying audio information shown in FIG. 1 is applicable to an electronic device, which can be a smart phone, a tablet computer, a smart television, an electronic-book reader, a multimedia player, a laptop portable computer, a desktop computer and so on. The method for identifying audio information can comprise the following steps:

In step 101, audio that is being played is identified by the electronic device to obtain audio information of the audio. Audio may be a song, an audio book, a language program played by other device or broadcast via radio. Audio information is information that describes details about content of audio. Audio information may include a title of a song, a length of a song, a name of an artist, lyrics, a topic of discussion, a subject of a language program, etc.

In step 102, hyperlinks that are configured for keywords in the audio information are displayed on an information presentation interface of the electronic device. For example, keywords may include a title of a song, an artist name, etc. A hyperlink is a reference to data that a user can directly follow either by clicking or touching. A hyperlink points to a whole document or to a specific element within a document. Specifically, hyperlinks described herein are references pointing to data that would be shown on a new page or a new window on a screen of a device.

In step 103, when the hyperlinks are triggered, pre-stored information corresponding to the keywords is displayed on the information presentation interface.

To sum up, in the method for identifying audio information provided in the embodiment of the disclosure, the audio information of the audio that is being played is obtained by identifying the audio, the hyperlinks that are configured for the keywords in the audio information are displayed, and the prestored information corresponding to the keywords is displayed when the hyperlinks are triggered. As more information corresponding to the audio can be displayed by providing the hyperlinks, the present disclosure addresses the problem that information to be displayed is limited, and provides useful information pursued by users.

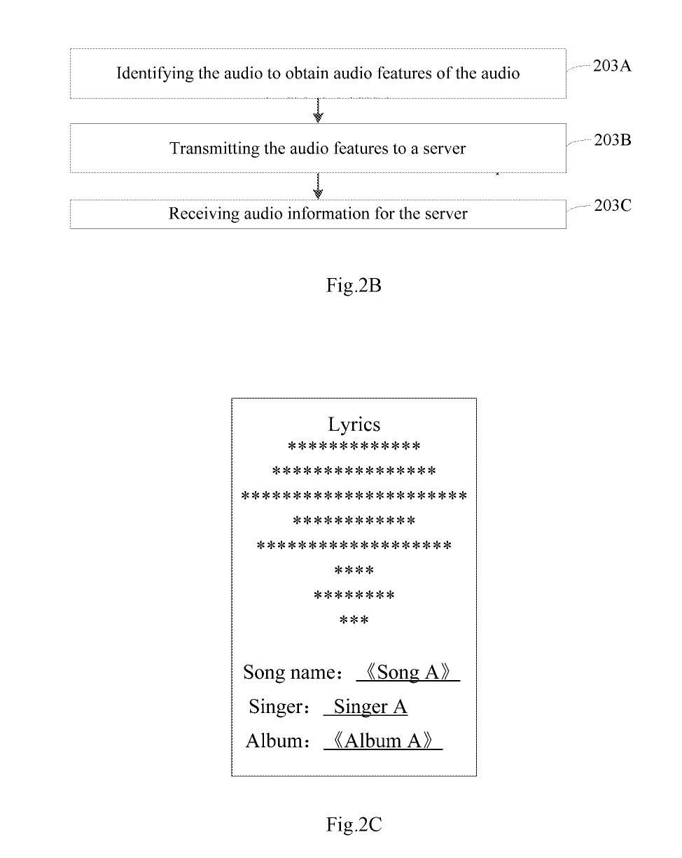

FIG. 2A is a flow chart illustrating a method for identifying audio information in accordance with another exemplary embodiment. The method for identifying audio information shown in FIG. 2A is applicable to the electronic device, which can be the smart phone, the tablet computer, the smart television, the electronic-book reader, the multimedia player, the laptop portable computer, the desktop computer and so on. The method for identifying audio information can include the following steps. Before identifying the audio that is being played, the electronic device obtains the audio that is being played. In order to satisfy different requirements, it is also required to correspondingly adjust the way that the electronic device obtains the audio that is being played.

In step 201, the audio that is being played is obtained every predetermined time interval. The audio that is being played can be audio that is being played by the electronic device by receiving radio broadcast, or audio that is being played by another device near the electronic device (at this time, the electronic device can obtain the audio that is being played by the other device). The audio can be, for example, music audio, language program audio, or book audio.

The electronic device can obtain the audio that is being played every other predetermined time interval, which can be for example, 3 minutes, 4 minutes or 5 minutes, set by a user. For example, the electronic device records and stores audio being played by other device or broadcast every three minutes or four minutes.

Alternatively, in order to reduce power consumption of the electronic device, the electronic device can obtain the audio that is being played upon determining that a change exceeding a predetermined threshold occurs in the rhythm of the audio. For example, when playing multiple songs continuously, a time interval usually exists after a song is completely played and before a next song is played, and the rhythm of the audio during the time interval is significantly different from that when the song is being played. Therefore, when the electronic device determines that the change exceeding the predetermined threshold occurs in the rhythm of the audio, which means that the song that is being played is switched, the audio obtained by the electronic device at the moment is the audio of the switched song.

In step 202, an identification instruction to identify the audio that is being played is received from a user, and the audio that is being played is obtained.

In order to meet the user's request and reduce the power consumption of the electronic device due to frequent audio identification, the electronic device can obtain the audio that is being played upon receiving the identification instruction triggered by the user to identify the audio that is being played.

In an implementation scenario, when the user is listening to radio broadcast by using the electronic device and founds the audio interesting and wishes to obtain relevant information of the audio, the user can trigger the generation of the identification instruction to identify the audio that is being played on the electronic device, and the electronic device will obtain the audio that is being played upon receiving the identification instruction.

In another implementation scenario, when another device is playing audio and the user wishes to obtain the relevant information of the audio that is being played by the other device, the user can turn on its own electronic device and triggers the generation of the identification instruction to identify the audio that is being played on the electronic device, and the electronic device will obtain the audio that is being played upon receiving the identification instruction.

Alternatively, when triggering the generation of the identification instruction to identify the audio that is being played on the electronic device, the user can trigger an identification control on the electronic device to generate the identification instruction, or trigger a specific hardware (for example, a volume key) of the electronic device to generate the identification instruction.

In step 203, the audio that is being played is identified to obtain the audio information of the audio. When identifying the audio that is being played, the electronic device can extract audio features of the audio and then transmit the audio features to a server for matching by the server so as to obtain the audio information. More details are described with reference to the following steps 203A-203C in. FIG. 2b, which is a flow chart illustrating a method for obtaining audio information in accordance with an exemplary embodiment.

In step 203A, the audio is identified to obtain the audio features of the audio. The audio features are associated with text information and/or identity information of the audio.

The electronic device identifies the audio that is being played to obtain audio features of the audio. Audio features are physical characteristics of audio including text, tone or pitch features occurring in the audio. If the audio is identified by a voice identification technology, the audio features may further include identity information of the audio. For example, when the obtained audio is a music, the obtained text information is lyrics corresponding to the obtained audio, and the identity information obtained by means of voice identification is a singer corresponding to the audio. When the obtained audio is language program audio, the obtained text information is program contents corresponding to the obtained audio, and the identity information obtained by means of voice identification is an entertainer corresponding to the audio.

In step 203B, the audio features are transmitted to the server. The audio features are used to trigger the server to look up the audio information matching with the audio features and feed back the audio information that is looked up.

The electronic device transmits the obtained audio features to the server. The server can look up the audio information matching with the audio features in a prestored database, and feed back the audio information matching with the audio features to the electronic device after the audio information is looked up.

The audio information can include owner information of the audio corresponding to the audio features, an audio name corresponding to the audio, and so on. For example, when the audio that is being played is music, the audio information can include a title of the music, an album name, a singer name, lyrics and so on. When the audio that is being played is the language program audio, the audio information can include a program name, an entertainer name and so on. When the audio that is being played is the book audio, the audio information can comprise a book author name, a book name, a chapter directory and so on.

In step 203C, the audio information is received from the server.

In step 204, hyperlinks including keywords in the audio information are displayed on the information presentation interface.

The electronic device can configure the hyperlinks including the keywords in the audio information upon receiving the audio information from the server, so as to facilitate the user obtaining more information via the jump links.

Here, the keywords can be keywords describing primary features of the audio. For example, when the audio that is being played is music, keywords can be a title of the music, a singer name, an album name and so on. When the audio that is being played is language program audio, keywords can be a program name, an entertainer name and so on. When the audio that is being played is an audio book, the keywords can be an author name, a name of the book and so on.

FIG. 2C is a diagram illustrating the displaying of audio information and hyperlinks in accordance with an exemplary embodiment. FIG. 2C takes the music audio as an example, in which the audio information received by the electronic device is “Song name: <Song A>”, “Singer: Singer A”, “Album: <Album A>”, and lyrics corresponding to Song A. The electronic device configures the hyperlinks for “<Song A>”, “Singer A”, and “Album A” respectively, and displays “Song name: <Song A>”, “Singer: Singer A”, “Album: <Album A>”, and lyrics corresponding to Song A on the information presentation interface.

In step 205, when the hyperlinks are triggered, the prestored information corresponding to the keyword included the hyperlink is displayed.

When the hyperlink on the information presentation interface is triggered, the electronic device displays the prestored information corresponding to the keyword. The pre-stored information may be detailed information with respect to the keywords. For example, when the audio that is being played is music and the hyperlink for a name of a singer is triggered, the electronic device opens a page displaying detailed materials of the singer. When the audio that is being played is language program audio, and the hyperlink for the program name is triggered, the electronic device jumps to a page displaying detailed instructions for the program. When the audio that is being played is an audio book, and the hyperlink for the book author is triggered, the electronic device jumps to a page displaying a column of the book author.

FIG. 2D is a diagram illustrating the displaying of jump pages in accordance with an exemplary embodiment. FIG. 2D also takes a music as an example, in which when “Singer A” on the information presentation interface is triggered, the electronic device jumps to the page displaying the detailed materials of Singer A.

In order to facilitate the user consulting the obtained audio information, the electronic device can correspondingly store the audio information and the hyperlinks upon displaying the hyperlinks that are configured for the keywords in the audio information on the information presentation interface. More details are described with reference to steps 206-207.

In step 206, when the hyperlinks are displayed, the audio information and the hyperlinks are automatically preserved in a prestored list.

Upon displaying the hyperlinks that are configured for the keywords in the audio information and the audio information on the information presentation interface, the electronic device can automatically preserve the audio information and the hyperlinks in the pre-stored list. The user can look up the preserved audio information in the prestored list.

In step 207, a preservation instruction for instructing to preserve the audio information and the hyperlinks is received, and the audio information and the hyperlinks are preserved in the prestored list.

Upon displaying the hyperlinks that are configured for the keywords in the audio information and the audio information on the information presentation interface, the electronic device can ask the user whether to preserve the audio information and the hyperlinks, and preserve the audio information and the hyperlinks in the prestored list upon receiving the preservation instruction for instructing to preserve the audio information and the hyperlinks.

Alternatively, the electronic device can display a preservation control for preserving the audio information and the hyperlinks on the information presentation interface, and preserve the audio information and the hyperlinks in the prestored list upon detecting that the preservation control is triggered.

In an implementation scenario, when a vehicle-mounted system of the user is receiving radio broadcast and playing a song, the user can identify the audio that is being played by using the vehicle-mounted system or a portable smart phone, and the vehicle-mounted system or the portable smart phone can obtain the audio information of the audio, display the hyperlinks that are configured for the keywords in the audio information on the information presentation interface, and display the prestored information corresponding to the keywords when the user triggers the hyperlinks. If the hyperlinks are displayed by the vehicle-mounted system, in order to avoid affecting the user driving a vehicle due to the user concentrating on the hyperlinks or the pre-stored information corresponding to the hyperlinks displayed on the vehicle-mounted system, the vehicle-mounted system can automatically store the hyperlinks and the audio information in the prestored list so as to facilitate the user browsing the hyperlinks and the audio information in the prestored list when it is convenient for him. Obviously, the user can also trigger the preservation control for preserving the audio information and the hyperlinks, and the vehicle-mounted system or the portable mobile phone can store the audio information and the hyperlinks in the pre-stored list for browsing by the user when it is convenient for him upon receiving the preservation instruction generated by the user triggering the preservation control.

To sum up, in the method for identifying audio information provided in the embodiment of the disclosure, the audio information of the audio that is being played is obtained by identifying the audio, the hyperlinks that are configured for the keywords in the audio information are displayed, and the prestored information corresponding to the keywords is displayed when the hyperlinks are triggered. As more information corresponding to the audio can be displayed by providing the hyperlinks, the problem that information to be displayed is relatively less due to displaying the audio information merely within a single interface is solved, and the effect of improving diversity of the audio information is achieved.

Furthermore, the audio information and the hyperlinks are preserved in the prestored list, and the audio information of the identified audio can be looked up in the prestored list, so the problem that the user cannot consult the audio information of the recently identified audio is solved, and the effect of improving the convenience of looking up the audio information is achieved.

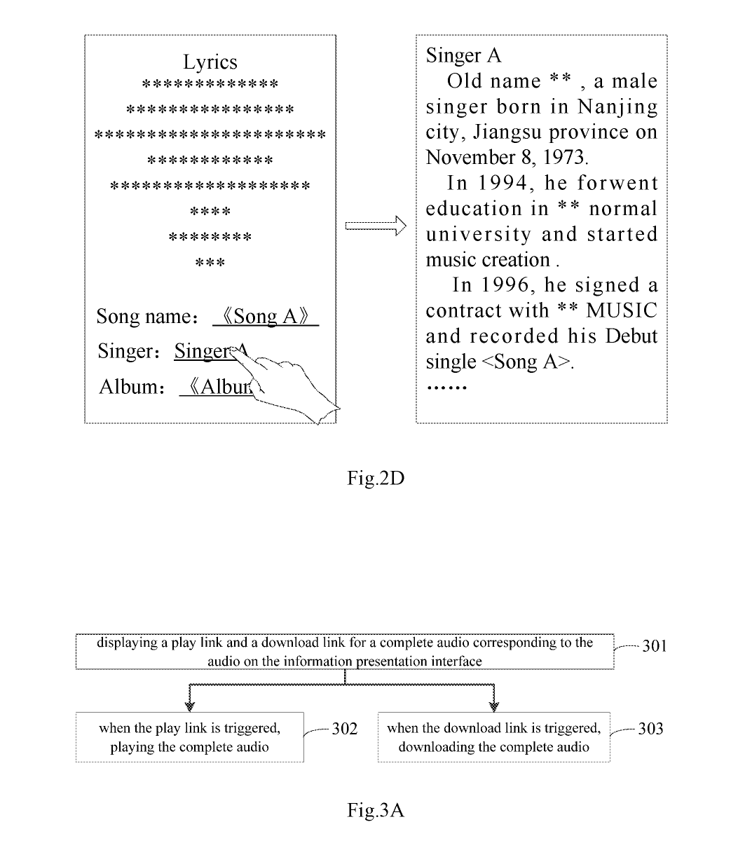

In order to facilitate the user enjoying the audio that he is listening to once again or collecting the audio that he is listening to, when displaying the hyperlinks that are configured for the keywords in the audio information, the electronic device can also display a play link and a download link for a complete audio corresponding to the audio. FIG. 3A is a flow chart illustrating a method for playing or downloading audio that is being listened to in accordance with an exemplary embodiment.

In step 301, the play link and the download link for the audio are displayed on the information presentation interface.

The electronic device can obtain the play link and the download link for the complete audio corresponding to the audio in accordance with the obtained audio information, and display the play link and the download link on the information presentation interface.

For example, when the obtained audio information comprises a name of a song, the play link and the download link for the song corresponding to the title of the song are displayed. When the obtained audio information comprises a language program name, the play link and the download link for the language program audio corresponding to the language program name are displayed. When the obtained audio information comprises a title of an audio book, the play link and the download link for the audio book corresponding to the title of the audio book are displayed.

FIG. 3B is a diagram illustrating the displaying of a play link and a download link for audio in accordance with an exemplary embodiment. FIG. 3B takes music as an example, in which the electronic device displays the play link 311 for playing Song A and the download link 322 for downloading Song A on the information presentation interface.

It should be noted that when the obtained audio information comprises a title of the audio book, the electronic device can also display the download link for downloading the audio book and the link for reading the audio book on line. When the obtained audio information comprises a program name, and there is a program video corresponding to the program name, the electronic device can also display the download link for downloading the program video and the play link for playing the program video. The program video may be pre-stored in the electronic device. In other example, the electronic device may download the program video from a server such as a cloud server.

In step 302, when the play link is triggered, the complete audio is played. The complete audio may be pre-stored in the electronic device. Alternatively, the electronic device may record the complete audio while the audio is broadcast on the radio or played by other devices. The recorded or pre-stored complete audio may be played in response to the play link being triggered.

In step 303, when the download link is triggered, the complete audio file is downloaded. For example, the electronic device may download an audio file corresponding to the audio from a server, or download the audio from other device that stores the complete audio file. The audio file may include music with better sound quality than music included in the audio. The electronic device plays the complete audio corresponding to the obtained audio upon detecting that the play link is triggered. The electronic device downloads the complete audio corresponding to the obtained audio upon detecting that the download link is triggered.

To sum up, in the above embodiment of the disclosure, the play link and the download link for the complete audio corresponding to the audio are displayed on the information presentation interface, and the complete audio is played when the play link is triggered and is downloaded when the download link is triggered. As the play link and the download link are provided on the information presentation interface, the problem that when the user wants to enjoy once again or collect the audio that he is listening to, it is required for him to perform complex operations of opening a corresponding program to search for the audio and then playing or downloading the audio is solved, and the effect of simplifying the operations and improving operation efficiency is achieved.

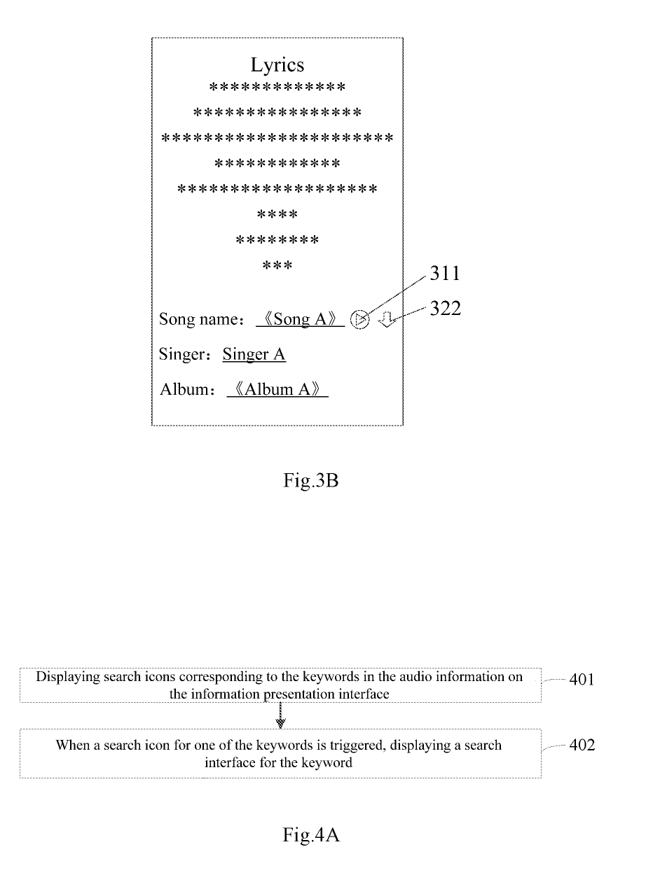

In order to facilitate the user further understanding the keywords in the audio information, the electronic device can further display search icons respectively corresponding to the keywords in the audio information while displaying the hyperlinks that are configured for the keywords in the audio information. FIG. 4A is a flow chart illustrating a method for searching for a keyword in audio information.

In step 401, the search icons corresponding to the keywords in the audio information are displayed on the information presentation interface. In order to display more information corresponding to the keywords so as to enable the user to further understand information related to the keywords, the electronic device can display the search icons corresponding to the keywords in the audio information on the information presentation interface.

In step 402, when the search icon of a keyword is triggered, a search interface for the keyword is displayed. The search interface displays search results corresponding to the keyword.

Upon determining that the search icon for a keyword on the information presentation interface is triggered, the electronic device displays the search icon for the keyword and displays the search results corresponding to the keyword on the search interface.

FIG. 4B is a diagram illustrating the displaying of search results corresponding to a keyword in accordance with an exemplary embodiment. FIG. 4B takes the music audio as an example, in which the electronic device displays the search interface corresponding to Singer A and displays the search results corresponding to Singer A on the search interface upon detecting that the search control 411 for Singer A is triggered.

To sum up, in the above embodiment of the disclosure, when the search icon for a keyword is triggered, the search interface for the keyword is displayed, wherein the search interface displays the search results corresponding to the keyword. As the search icons for searching for the keywords are displayed on the information presentation interface, the present disclosure addresses inconvenience that it is required to open another application program to search for the keywords, and simplifies the operations and improves operation efficiency.

It should be noted that the steps in FIG. 2A and FIG. 3A can be incorporated into an embodiment, the steps in FIG. 2A and FIG. 4A can be incorporated into an embodiment, and the steps in FIG. 2A, FIG. 3A, and FIG. 4A can be incorporated into an embodiment.

The following are apparatus embodiments of the disclosure, which can be used to implement the method embodiments of the disclosure. The above description in relation with the method embodiments of the disclosure is similarly applied to the apparatus embodiments.

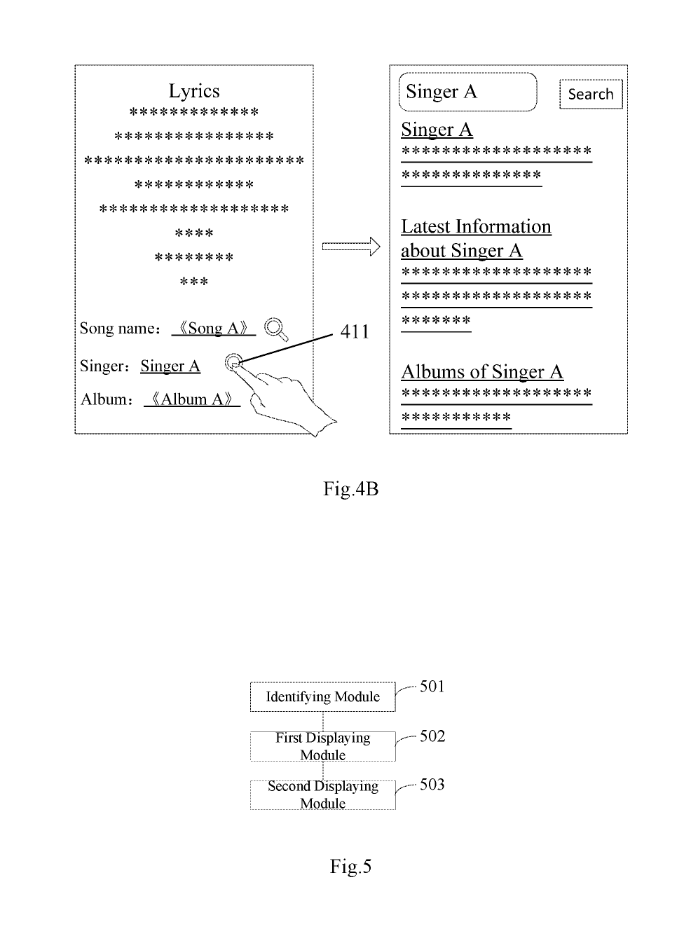

FIG. 5 is a block diagram illustrating an apparatus for identifying audio information in accordance with an exemplary embodiment. As shown in FIG. 5, the apparatus for identifying audio information is applicable to the electronic device, for example, a smart phone, a tablet computer, an electronic-book reader, a multimedia player, a laptop portable computer, a desktop computer and so on. The apparatus for identifying audio information includes an identifying module 501, a first displaying module 502, and a second displaying module 503.

The identifying module 501 is configured to identify the audio that is being played to obtain the audio information of the audio.

The first displaying module 502 is configured to display the hyperlinks that are configured for the keywords in the audio information obtained by the identifying module 501 on the information presentation interface.

The second displaying module 503 is configured to display the prestored information corresponding to the keywords when the hyperlinks displayed by the first displaying module 502 are triggered.

To sum up, in the apparatus for identifying audio information provided in the embodiment of the disclosure, the audio information of the audio that is being played is obtained by identifying the audio, the hyperlinks that are configured for the keywords in the audio information are displayed, and the prestored information corresponding to the keywords is displayed when the hyperlinks are triggered. As more information corresponding to the audio can be displayed by providing the hyperlinks, the problem that information to be displayed is relatively less due to displaying the audio information merely within a single interface is solved, and the effect of improving diversity of the audio information is achieved.

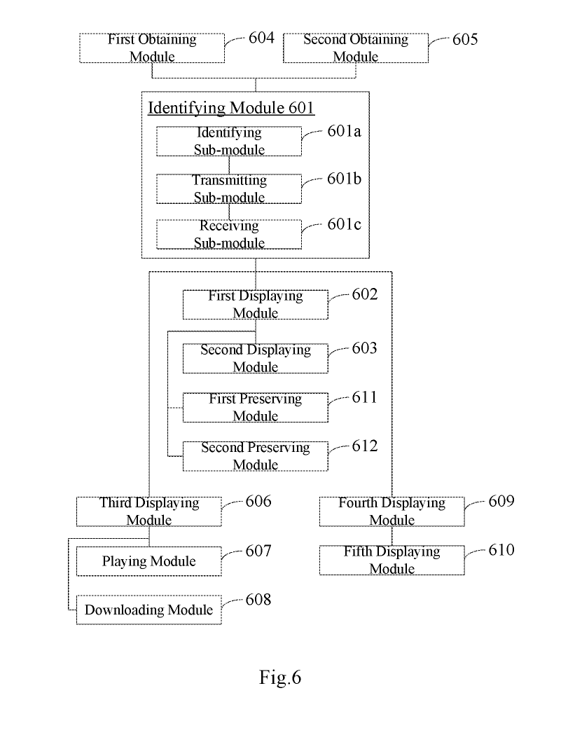

FIG. 6 is a block diagram illustrating an apparatus for identifying audio information in accordance with another embodiment of the disclosure. As shown in FIG. 6, the apparatus for identifying audio information is applicable to the electronic device, for example, a smart phone, a tablet computer, an electronic-book reader, a multimedia player, a laptop portable computer, a desktop computer, and so on. The apparatus for identifying audio information includes an identifying module 601, a first displaying module 602, and a second displaying module 603.

The identifying module 601 is configured to identify the audio that is being played to obtain the audio information of the audio.

The first displaying module 602 is configured to display the hyperlinks that are configured for the keywords in the audio information obtained by the identifying module 601 on the information presentation interface.

The second displaying module 603 is configured to display the prestored information corresponding to the keywords when the hyperlinks displayed by the first displaying module 602 are triggered.

In a possible embodiment, the identifying module 601 includes an identifying sub-module 601a, a transmitting sub-module 601b, and a receiving sub-module 601c.

The identifying sub-module 601a is configured to identify the audio to obtain the audio features of the audio. The audio features may include text information and/or the identity information of the audio.

The transmitting sub-module 601b is configured to transmit the audio features obtained by the identifying sub-module 601a to a server. The audio features are used to trigger the server to look up the audio information matching with the audio features and feed back the audio information that is looked up.

The receiving sub-module 601c is configured to receive the audio information from the server.

In a possible embodiment, the apparatus for identifying audio information includes a first obtaining module 604 or a second obtaining module 605.

The first obtaining module 604 is configured to obtain the audio that is being played every other predetermined time interval. The second obtaining module 605 is configured to receive the identification instruction to identify the audio that is being played and obtain the audio that is being played.

In a possible embodiment, the apparatus for identifying audio information also includes a third displaying module 606, a playing module 607, and a downloading module 608.

The third displaying module 606 is configured to display the play link and the download link for complete audio corresponding to the audio on the information presentation interface.

The playing module 607 is configured to play the complete audio when the play link displayed by the third displaying module 606 is triggered.

The downloading module 608 is configured to download the complete audio when the download link displayed by the third displaying module 606 is triggered.

In a possible embodiment, the apparatus for identifying audio information can further comprise a fourth displaying module 609 and a fifth displaying module 610.

The fourth displaying module 609 is configured to display the search controls corresponding to the keywords in the audio information on the information presentation interface.

The fifth displaying module 610 is configured to display the search interface for a keyword displayed by the fourth displaying module 609 when a search icon for the keyword is triggered, wherein the search interface displays the search results corresponding to the keyword.

In a possible embodiment, the apparatus for identifying audio information can further comprise a first preserving module 611 or a second preserving module 612.

The first preserving module 611 is configured to automatically preserve the audio information and the hyperlinks in the pre-stored list upon displaying the hyperlinks.

The second preserving module 612 is configured to receive the preservation instruction for instructing to preserve the audio information and the hyperlinks and preserve the audio information and the hyperlinks in the pre-stored list.

To sum up, in the apparatus for identifying audio information provided in the embodiment of the disclosure, the audio information of the audio that is being played is obtained by identifying the audio, the hyperlinks that are configured for the keywords in the audio information are displayed, and the prestored information corresponding to the keywords is displayed when the hyperlinks are triggered. As more information corresponding to the audio can be displayed by providing the hyperlinks, the problem that information to be displayed is relatively less due to displaying the audio information merely within a single interface is solved, and the effect of improving diversity of the audio information is achieved.

Furthermore, the audio information and the hyperlinks are preserved in the prestored list, and the audio information of the identified audio can be looked up in the prestored list. So the problem that the user cannot consult the audio information of the recently identified audio is solved, and the effect of improving the convenience of looking up the audio information is achieved.

Furthermore, the play link and the download link for the complete audio corresponding to the audio are displayed on the information presentation interface, and the complete audio is played when the play link is triggered and is downloaded when the download link is triggered. As the play link and the download link are provided on the information presentation interface, the problem that when the user wants to enjoy once again or collect the audio that he is listening to, it is required for him to perform complex operations of opening a corresponding program to search for the audio and then playing or downloading the audio is solved, and the effect of simplifying the operations and improve operation efficiency is achieved.

Furthermore, when the search control for a keyword is triggered, the search interface for the keyword is displayed, wherein the search interface displays the search results corresponding to the keyword. As the search controls for searching for the keywords are displayed on the information presentation interface, the problem that it is required to open another application program to search for the keywords and the number of operation steps is relatively large is solved, and the effect of improving operation efficiency is achieved.

Specific ways that respective modules in the apparatuses in the above embodiments perform operations have already been described in detail in the method embodiments, and thus are not redundantly described herein.

An embodiment of the disclosure provides an apparatus for identifying audio information capable of implementing the methods for identifying audio information provided by the disclosure, the apparatus comprising a processor and a memory for storing instructions executable by the processor, wherein the processor is configured to identify the audio that is being played to obtain the audio information of the audio; display the hyperlinks that are configured for the keywords in the audio information on the information presentation interface; when the hyperlinks are triggered, display the prestored information corresponding to the keywords.

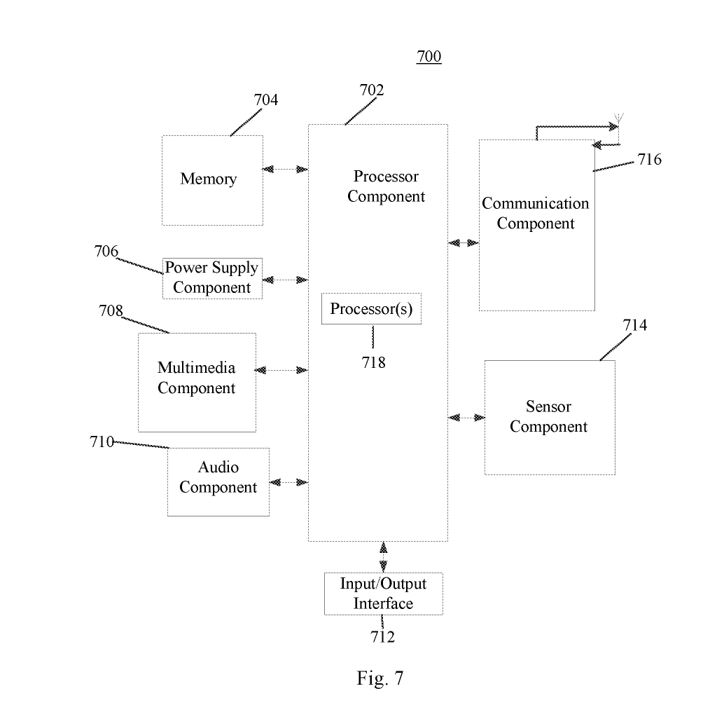

FIG. 7 is a block diagram illustrating an apparatus for identifying audio information in accordance with an exemplary embodiment. For example, the apparatus 700 can be a mobile phone, a computer, a digital broadcast terminal, a message transceiver, a game console, a tablet device, a fitness facility, a personal digital assistant and so on.

As shown in FIG. 7, the apparatus 700 can comprise one or more of a processor component 702, a memory 704, a power supply component 706, a multimedia component 708, an audio component 710, an input/output (I/O) interface 712, a sensor component 714, and a communication component 716.

The processor component 702 usually controls operations of the whole apparatus 700, for example, operations related to display, telephone call, data communication, camera operation and recording operation and so on. The processor component 702 can comprises one or more processors 718 to execute instructions so as to implement all or part of the steps of the above methods. Moreover, the processor component 702 can comprise one or more modules for facilitating interactions between the processor component 702 and other components. For example, the processor component 702 can comprise a multimedia module for facilitating interactions between the multimedia component 708 and the processor component 702.

The memory 704 is configured to store various types of data for supporting operations of the apparatus 700. Examples of the data comprise instructions of any application program or method operating on the apparatus 700, contact data, directory data, messages, pictures, videos and so on. The memory 704 can be implemented by any type of volatile or non-volatile storages or the combination thereof, for example, Static Random Access Memories (SRAMs), Electrically Erasable Programmable Read-Only Memories (EEPROMs), Erasable Programmable Read-Only Memories (EPROMs), Programmable Read-Only Memories (PROMs), Read-Only Memories (ROMs), magnetic memories, flash memories, magnetic disks or optical disks.

The power supply component 706 supplies power for various components of the apparatus 700. The power supply component 706 can comprise a power supply management system, one or more power supplies, and other components associated with power generation, management and assignment for the apparatus 700.

The multimedia component 708 comprises a screen for providing an output interface between the apparatus 700 and the user. In some embodiments, the screen can comprise a liquid crystal display (LCD) and a touch panel (TP). If the screen comprises the touch panel, the screen can be implemented as a touch sensitive screen to receive input signals from the user. The touch panel comprises one or more touch sensors for sensing touch, slide, and gestures on the touch panel. The touch sensors can not only sense boundaries of a touch or slide action, but also detect duration and pressure related to a touch or slide operation. In some embodiments, the multimedia component 708 comprises a front camera and/or a rear camera. When the apparatus 700 is in operation (for example, in a camera mode or a video mode), the front camera and/or the rear camera can receive multimedia data from external. Each of the front camera and the rear camera can be a fixed optical lens system or has a focus and optical zoom capability.

The audio component 710 is configured to output and/or input audio signals. For example, the audio component 710 comprises a microphone (MIC). When the apparatus 700 is in operation (for example, in a call mode, a recording mode, or a voice identification mode), the microphone is configured to receive the audio signals from external. The received audio signals can be further stored in the memory 704 or transmitted via the communication component 716. In some embodiments, the audio component 710 further comprises a speaker for outputting the audio signals.

The I/O interface 712 provides an interface between the processor component 702 and peripheral interface modules such as a keyboard, a click wheel, buttons and so on. The buttons can comprise but are not limited to homepage buttons, volume buttons, start buttons and lock buttons.

The sensor component 714 comprises one or more sensors for providing various aspects of state elevations for the apparatus 700. For example, the sensor component 714 can detect On/Off state of the apparatus 700, and relative positions of the components (for example, a display and a keypad of the apparatus 700). The sensor component 714 can further detect the change of position of the apparatus 700 or a component of the apparatus 700, the presence of the touching by the user on the apparatus 700, location or acceleration/deceleration of the apparatus 700, and temperature change of the apparatus 700. The sensor component 714 can comprise a proximity sensor configured to detect the presence of a neighboring object without any physical touch. The sensor component 714 can further comprise an optical sensor such as a CMOS or CCD image sensor applicable for imaging. In some embodiments, the sensor component 714 can further comprise an acceleration sensor, a gyroscope sensor, a magnetic sensor, a pressure sensor or a temperature sensor.

The communication component 716 is configured to facilitate wireless or wire communication between the apparatus 700 and other devices. The apparatus 700 can access wireless networks based on communication standards such as 2G, 3G, or the combination thereof. In an exemplary embodiment, the communication component 716 receives broadcast signals or broadcast related information from an external broadcast management system via a broadcast channel. In an exemplary embodiment, the communication component 716 further comprises a near field communication (NFC) module for facilitating short range communication. For example, the NFC module can be implemented based on a Radio Frequency Identification (RFID) technology, an Infrared Data Association (IrDA) technology, an Ultra Wideband (UWB) technology, a Blue Tooth (BT) technology and other technologies.

In an exemplary embodiment, the apparatus 700 can be implemented by one or more Application Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, microcontrollers, microprocessors, or other electronic elements so as to implement the above methods for identifying audio information.

In an exemplary embodiment, a non-temporary computer readable storage medium (for example, the memory 704 comprising instructions) comprising instructions executable by the processor 718 of the apparatus 700 to implement the above methods for identifying audio information is provided. For example, the non-temporary computer readable storage medium can be a ROM, a Random Access Memory (RAM), a CD-ROM, a magnetic tape, a floppy disk, an optical data storage device and so on.

Each module discussed above, such as the identifying module 501, the first displaying module 502, and the second displaying module 503, may take the form of a packaged functional hardware unit designed for use with other components, a portion of a program code (e.g., software or firmware) executable by the processor or the processing circuitry that usually performs a particular function of related functions, or a self-contained hardware or software component that interfaces with a larger system, for example.

The person skilled in the art will readily think of other embodiments of the disclosure upon considering the specification and practicing the invention disclosed herein. The application is intended to cover any modifications, usages or adaptive variations of the disclosure, wherein the modifications, usages or adaptive variations follow general principles of the disclosure and comprise common sense or customary technical means in the art that are not disclosed in the disclosure. The specification and embodiments are merely considered as illustrative, and the scopes and spirits of the disclosure are limited by the following claims.

It should be noted that the disclosure is not limited to the precise structures described above and shown in the accompany drawings, and can be modified and changed without departing the scopes of the disclosure. The scopes of the disclosure are limited merely by the accompany claims.

What is claimed is:

1. A method for identifying audio information using a device, comprising:
obtaining audio that is being played;
extracting audio features from the audio;
transmitting the audio features to a server, the audio features being matched with audio information stored in the server;
receiving the audio information from the server;
displaying a hyperlink including a keyword in the audio information on a screen of the device; and
displaying prestored information related to the keyword when the hyperlink is triggered.

2. The method of claim 1, wherein the audio features include at least one of text information, or identity information on the audio.

3. The method of claim 1, wherein obtaining audio that is being played comprises
recording and storing the audio in the device.

4. The method of claim 1, further comprising:
displaying a play link for the audio on the screen of the device; and
playing the audio from a beginning of the audio in response to the play link being triggered.

5. The method of claim 1, further comprising:
displaying a download link for a complete audio file corresponding to the audio on the screen of the device; and
downloading the complete audio file in response to the download link being triggered.

6. The method of claim 1, further comprising:
displaying a search icon corresponding to the keyword in the audio information on the screen of the device; and
when a search icon for a keyword is triggered, displaying a search interface for the keyword, wherein search results corresponding to the keyword are displayed on the search interface.

7. The method of claim 1, further comprising
upon displaying the hyperlink, automatically adding the audio information and the hyperlink in a pre-stored list.

8. The method of claim 1, wherein the audio that is being played is audio played by other device.

9. An apparatus for identifying audio information, comprising:
a processor; and
a memory for storing instructions executable by the processor,
wherein the processor is configured to:
obtain audio that is being played;
extract audio features from the audio;
transmit the audio features to a server, the audio features being matched with audio information stored in the server;
receive the audio information from the server;
display a hyperlink including a keyword in the audio information on a screen of the apparatus; and
display pre-stored information related to the keyword on the screen of the apparatus when the hyperlink is triggered.

10. The apparatus of claim 9, wherein the audio is music, and the audio information includes at least one of a title of the music, an artist of the music, or lyrics of the music.

11. The apparatus of claim 9, wherein obtaining the audio that is being played comprises obtaining the audio that is being played every predetermined time interval.

12. The apparatus of claim 9, wherein the processor is further configured to:
display a play link for the audio on the screen of the apparatus; and
play the audio from a beginning of the audio when the play link is triggered.

13. The apparatus of claim 9, wherein the processor is further configured to:
display a download link for a complete audio file corresponding to the audio on the screen of the apparatus; and
download the complete audio file when the download link is triggered.

14. The apparatus of claim 9, wherein the processor is further configured to:
display a search icon corresponding to the keyword in the audio information on the screen of the apparatus; and
display a search interface for the keyword when a search icon for the keyword is triggered, wherein search results corresponding to the keyword are displayed on the search interface.

15. A non-transitory computer-readable storage medium having stored therein instructions for identifying audio information that, when executed by a processor of a device, cause the device to:
obtain audio that is being played;
extract audio features from the audio;
transmit the audio features to a server, the audio features being matched with audio information stored in the server;
receive the audio information from the server;
display a hyperlink including a keyword in the audio information on a screen of the device; and
display pre-stored information related to the keyword on the screen of the device when the hyperlink is trigger.

16. The non-transitory computer-readable storage medium of claim 15, wherein the audio that is being played is music played by other device.

17. The non-transitory computer-readable storage medium of claim 15, wherein the audio that is being played is audio streaming broadcast online.

18. The non-transitory computer-readable storage medium of claim 15, wherein the audio that is played is an audio book broadcast wirelessly.

19. The non-transitory computer-readable storage medium of claim 15, wherein the method further comprises:
displaying a link for playing an audio file corresponding the audio on the screen of the device, wherein the audio file including a music with higher quality sound than a music included in the audio; and
playing the audio file when the link is triggered.

20. The non-transitory computer-readable storage medium of claim 15, wherein the method further comprises:
displaying a link for downloading an audio file corresponding to the audio on the screen of the device, wherein the audio file including a music with higher quality sound than a music included in the audio; and
download the audio file when the link is triggered.
